(19) United States
(12) Patent Application Publication
(10) Pub. No.: US 2007/0163493 A1
(43) Pub. Date: Jul. 19, 2007

(54) Feeding station for electrostatic powdering device

(76) Inventor: Adrien Lacchia, Saint Martin Le Vinoux (FR)

Correspondence Address: CANTOR COLBURN, LLP, 55 GRIFFIN ROAD SOUTH, BLOOMFIELD, CT, 06002, US

(21) Appl. No.: 10/572,006

(22) PCT Filed: Sep. 7, 2004
(86) PCT No.: PCT/FR04/02266

§ 371 Date: Dec. 11, 2006

(30) Foreign Application Priority Data
Sep. 10, 2003 (FR) 0310667

(51) Int. Cl. B05C 5/00

(52) U.S. Cl. 118/300

(57) ABSTRACT

The inventive feeding station (33) comprises an enclosure (34), a support on which at least a powder container (27) is arranged, an assembly (48) which consists of at least one powder air pump (49) mounted above the support and connected by one side thereof to a feeding flexible hose (17) of a gun and by the other side thereof to a rigid tube (50) for sucking out a powder from the powder container (27). Said assembly (48) is mounted on a mechanical module (52) enabling it to move vertically. The units for cleaning the suction tubes (50) are arranged below the support vertically with respect to said tubes (50). The support comprises a plate (44) which rotates around a vertical axis and is provided with at least one location (45) for the powder tank (27) and at least one opening (46) for the passage of the suction tubes (50).

The invention relates to a feeding station for an electrostatic powdering installation, in particular an installation for painting parts or any other surface treatment applying powder electrostatically.

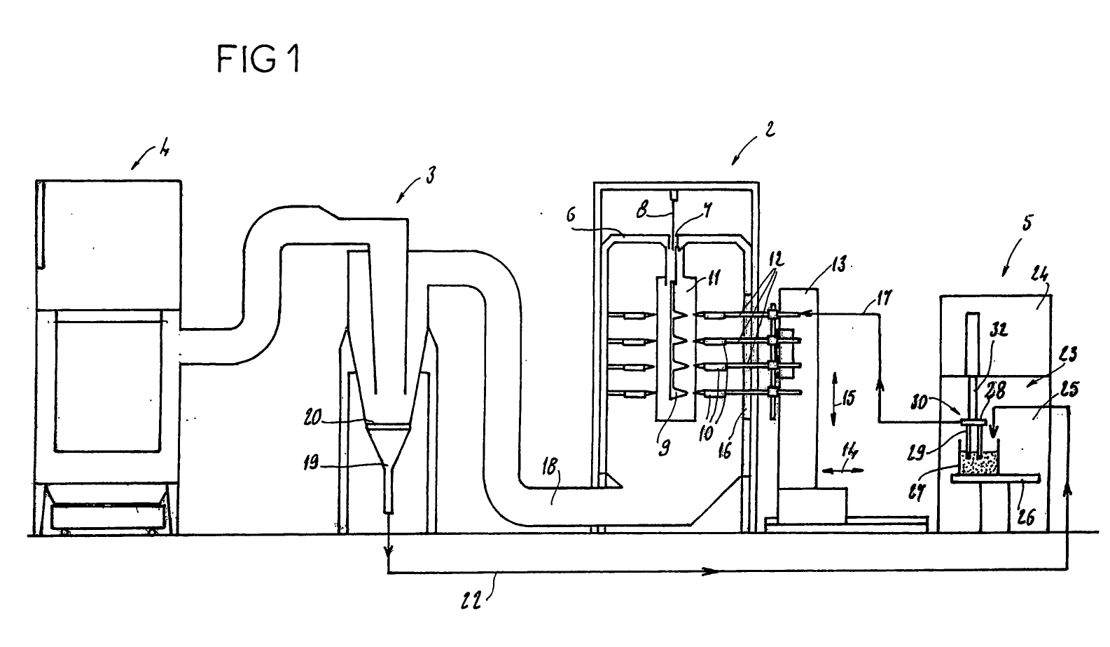

Current electrostatic powdering installations comprise, in a known manner as shown in FIG. 1, a spray booth 2, a cyclone 3, a final finisher filter 4 and a powder feeding station 5.

The spray booth 2 usually consists of a double wall made of plastic 6 delimiting an internal space having an opening 7 at its top allowing the passage of a conveyor and its swing tables 8 on which the parts 9 to be powdered are suspended, and two openings 11 on each of its two outer faces allowing the parts to enter and leave the booth 2.

During their passage in the booth 2, the parts 9 pass opposite an array of electrostatic guns 10 supported for example by a support arm 12 of a robot 13 capable of moving horizontally on the floor on a back-and-forth trajectory and vertically in a back-and-forth trajectory respectively materialized by the arrows 14 and 15.

The wall 6 also has one or more slots 16 allowing the passage of the support arms 12 of the robot 13, the guns 10 and their powder feeding pipes 17.

In addition, the wall 6 of the booth 2 usually has an opening not shown furnished where necessary with a door and intended to allow the work of a manual operator who may on certain complex parts 9, spray with a manual gun additional powder on the portions of the parts 9 that are inaccessible to the guns 10 supported by the robot 13.

To prevent the powder being dispersed toward the outside of the booth 2 via its openings, the booth 2 is connected to a fan, not shown, placed at the outlet of the final filter 4, which aspirates through a duct 18 a volume of air originating from outside the booth through the openings.

The aspirated air brings with it the portion of the powder sprayed by the guns but not deposited on the parts 9. This portion of the powder may represent between 10 and 60% of the powder sprayed by the guns 10.

This powder is drawn by the aspirated air via the duct 18, into the cyclone 3 where it is more than 95% separated from the air which then passes through the final filter 4.

The powder separated in the cyclone falls mechanically to the bottom 19 of the cyclone 3.

On its journey, it passes through the screen of a usually vibrating sifter 20 which retains the impurities that the aspiration air might have brought with it.

This purified powder is then returned via a pump, not shown, and a powder return pipe 22 toward the feeding station 5 to be recycled.

The few percent of powder consisting of very fine particles not separated at the cyclone are, for their part, separated from the aspiration air by the filtering medium of the final finisher filter 4 before the purified air is blown out into the workshop or to the outside of the building. This recovered powder is not reused but cleared away, for example at the end of the day.

The existing powder feeding stations 5 consist of an enclosure 23 built against an air aspiration and filtration unit 24 with which said enclosure communicates via a wall 25 consisting for example of a fine mesh grill. The enclosure contains a vibrated support 26 mounted on an oscillating unit on which is placed a powder tank 27, which can for example be the carton in which the powder is delivered or a fluidized trough, into which the powder return pipe 22 described hereinabove emerges.

A series of pneumatic powder pumps 28 is placed above the table, each pump being connected on one side to a flexible feeding pipe 17 of a gun 10 and on the other to a rigid powder suction pipe 29.

The powder feeding station 5 feeds the powder application guns 10 via flexible feeding pipes 17 from the powder tank 27 and thanks to the series of pneumatic pumps 28.

The assembly 30, consisting of the pneumatic powder pumps 28, the flexible pipes 17 for feeding the guns 10 and the rigid powder suction pipes 29, is mounted on a mechanical module 32 which moves it up and down.

A fan, not shown, placed at the outlet of the aspiration and filtration unit 24 aspirates air from the wall 25 of the station, drawing toward an absolute filter placed behind the wall 25 and connected directly to the fan contained in the unit 24 that the air passes through all the volatile powder which, for one reason or another, might come to be dispersed outside the tank 27.

This powder remains on the surface of the absolute filter while the air is blown out of the aspiration and filtration unit 24. This absolute filter is periodically and automatically unblocked, the powder deposited thereon then falling in a mass into the bottom of the aspiration unit 24. This wasted powder is periodically cleared away.

Currently, when carrying out a color change, the following operations have to be performed on the whole installation:
(a) roughly cleaning the booth 2, sifting, returning the powder to the tank 27,
(b) removing the bottom of the cyclone 19, the fan remaining in operation, and cleaning the sifter filter,
(c) installing the assembly 30 and removing the current powder tank 27,
(d) blowing the sifter 20 in the cyclone 3,
(e) lowering the assembly 30 and automatically blow-cleaning toward the booth the inside of the suction pipes 29, the inside of the flexible pipes 17 and the inside of the guns 10,
(f) withdrawing the robot 13 and automatically blow-cleaning the outside of the support arms 12 and the guns 10,
(g) installing the assembly 30 and blow-cleaning the outside of the suction pipes 29,
(h) meticulously cleaning the booth 2, by manual blowing or other means,
(i) cleaning the return pipe 22 from the station 5,
(k) putting in place a new powder tank 27 containing the new color on the support 26,
(l) lowering the assembly 30,
(m) closing the bottom of the cyclone 19 with the sifter 20,
(n) moving the robot 13 forward,
(o) starting feeding with a new color.

The order of the operations is given as an example, but some of them may also be carried out simultaneously or in a substantially different order. Certain operations may also be combined into a single operation.

These operations require some fifteen minutes with the intervention of two operators. It is therefore a costly operation, particularly for series of parts for which the colors must be changed frequently.

Furthermore, the operations (c, e, g, i, k, 1, o) involve the feeding station 5. The change of color therefore poses a technical problem: too many manual steps are necessary to carry out a change of color, particularly for the operations involving the feeding station 5.

In addition, a feeding station 5 must ensure that there is no contamination of one powder by the particles of a previous powder.

The present invention provides a solution to the technical problem raised while respecting the constraint described hereinabove.

Accordingly, the object of the present invention relates to a feeding station for an electrostatic powdering installation comprising at least one spray gun, comprising:
an enclosure having an opening toward the outside,
air aspiration and filtration means,
a support on which at least one powder tank is placed,
an assembly comprising at least one pneumatic powder pump placed above the support, each of the pumps being connected, on one side, to a flexible pipe for feeding a gun, and, on the other, to a rigid pipe for sucking the powder from the powder tank, this assembly being mounted on a mechanical module making it possible to move it vertically, means of cleaning the inside of the suction pipes and means of cleaning the outside of the suction pipes being placed beneath the support in vertical alignment with the suction pipes, the support comprising a movable table comprising at least one emplacement for a powder tank and at least one opening allowing the passage of the suction pipes and their vertical positioning by the mechanical module close to the automatic means of cleaning the inside of the suction pipes and of the automatic means of cleaning the outside of the suction pipes, an emplacement or an opening capable of being positioned in vertical alignment with the suction pipes by rotation and/or translation of the table in a substantially horizontal plane, characterized in that the means of cleaning the inside of the suction pipes and the means of cleaning the outside of the suction pipes are placed in a lower compartment situated beneath the enclosure and communicating with the enclosure through an opening made in its lower wall, this opening being left free by the rotating table, when the opening of the table is situated in vertical alignment with the suction pipes.

The disposition of the cleaning means makes it possible to prevent the powder present on the suction pipes from being dispersed in the enclosure, the cleaning being achieved in the lower compartment by pneumatic blowing through the nozzles.

Advantageously, the table is mounted to rotate about a substantially vertical axis, the positioning of an emplacement or of an opening in vertical alignment with the suction pipes being obtained by rotation of the table about the axis.

This configuration of the station makes it possible to clean the suction pipes and the gun feeding pipes automatically, by raising the suction pipes above the tank, by causing the table to pivot to present an opening, then by lowering the pipes close to the cleaning means. For a change of color, it is possible, during cleaning, to replace the tank of the old color on the emplacement that it occupied with a tank of a new color.

Advantageously, the aspiration in the enclosure is achieved through the side wall of the enclosure or through the opening made in the lower wall of the enclosure, the aspiration through the side wall being able in this case to be stopped.

When powder is fed by the station, the aspiration of the enclosure is through the side wall of the enclosure, in conventional fashion. During cleaning, the aspiration is through the lower compartment, making it possible to prevent the dispersion of powder, inside or outside the enclosure, originating from the cleaning performed in the lower compartment.

According to one embodiment, the means of cleaning the inside of the suction pipes comprise air blower nozzles, each of the blower nozzles being placed in vertical alignment with a suction pipe and the air jet emanating from the nozzles being directed substantially vertically upward and making it possible to clean the inside of a rigid suction pipe, and the inside of the pump and of the flexible pipe that are connected thereto.

According to one embodiment, the means of cleaning the outside of the suction pipes comprise air blower nozzles placed on at least one vertical support, the air jet emanating from the nozzles making it possible to clean the outside of the rigid suction pipes.

Advantageously, the blower nozzles intended to clean the outside of the rigid powder suction pipes produce an air jet directed obliquely downward, in the direction of the powder suction pipes when the latter are positioned vertically close to the means of cleaning the inside and outside of these pipes.

The downward orientation of the blower nozzles also prevents powder being dispersed toward the enclosure.

According to one embodiment, the rotating table comprises means of vibrating a powder tank placed on the table, in at least one emplacement of a powder tank.

According to one embodiment, the aspiration means comprise a fan connected to at least one top opening made in the side wall of the enclosure and to at least one bottom opening communicating with the lower compartment, at least one shutter making it possible to close off alternatively the top openings and the bottom openings, the aspiration being performed only through the lower compartment and the bottom openings during the cleaning of the suction pipes.

Advantageously, the feeding station comprises a powder return pipe originating from a cyclone opening into the powder tank and able to be raised above the tank.

According to one embodiment, the rotating table comprises at least two emplacements for a powder tank, so that a powder tank can be placed on the table on one emplacement while a first tank is being used.

Advantageously, the rotating table comprises two emplacements for a powder tank, diametrically opposed on the rotating table, and an opening situated at 90° from the two emplacements.

According to one embodiment, the filtering means consist of the wall of at least one filtration cartridge traversed by the aspiration air, this wall consisting of a filtering medium preventing powder particles from passing through, a movable receptacle being present beneath each cartridge, allowing the powder which has accumulated on the wall to be collected during the periodic unblocking operation.

Advantageously, the assembly comprises a powder return pipe whose end is placed vertically in a similar manner to the suction pipes and which is cleaned by the means of cleaning the inside of the suction pipes and the means of cleaning the outside of the suction pipes.

The invention will be better understood with the aid of the following description, with reference to the appended schematic drawing representing one embodiment of a feeding station according to the invention.

FIG. 1 is a schematic front view of a feeding station according to the prior art in its environment consisting of an electrostatic powdering installation.

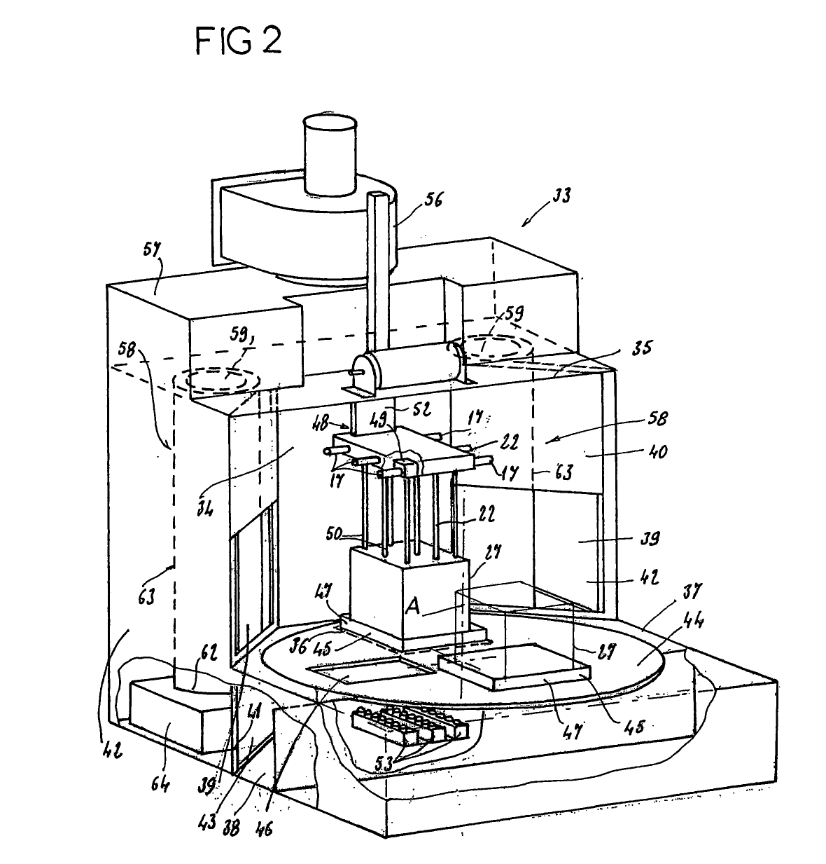

FIG. 2 is a view in perspective of the feeding station according to the invention.

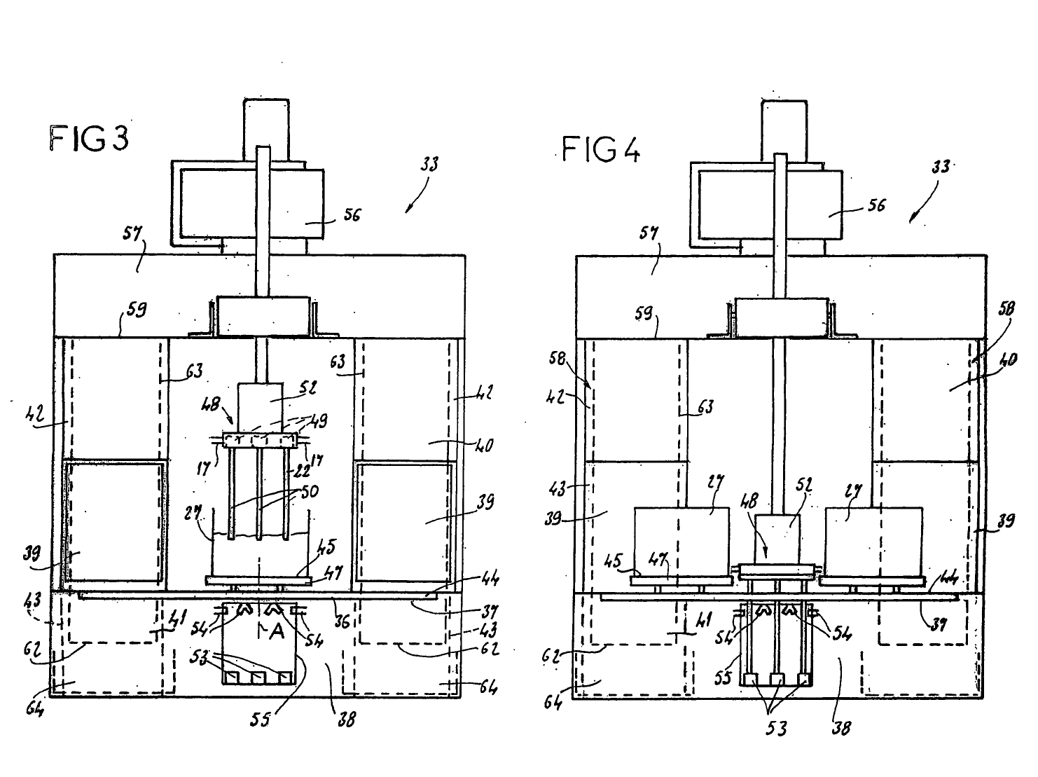

FIG. 3 is a front view of the feeding station of FIG. 2.

FIG. 4 is a front view of the feeding station of FIG. 2 in another operating position.

A feeding station 33 according to the invention is situated in the same environment as a feeding station 5 according to the prior art represented in FIG. 1. This station 33 forms part of an electrostatic powdering installation, comprising a spray booth 2, a cyclone 3 and a final filter 4. It is connected by flexible feeding pipes 17 to the spray guns and by the powder return pipe 22 from the cyclone 3 to the tank 27.

A feeding station 33 according to the invention comprises an enclosure 34 having an opening 35 toward the outside, allowing an operator to access this enclosure and install new powder tanks 27 or remove tanks 27.

The enclosure 34 has an opening 36 on its lower wall 37, making it possible to communicate with a lower compartment 38 situated below the enclosure 34.

Furthermore, the enclosure 34 has two top openings 39 in its side wall 40 making it possible to communicate with two side compartments 42 situated behind and to the side of the enclosure 34.

Each side compartment 42 communicates via its lower portion with the lower compartment 38 situated level with the mechanical module 52 through a bottom opening 41 situated in vertical alignment with the top opening 39 of this compartment 42 beneath the latter.

A movable shutter 43 that can slide down makes it possible to alternatively close the top opening 39 of the side compartment 42 toward the enclosure 34 or the bottom opening 41 of the compartment 42 toward the lower compartment 38.

The feeding station 33 comprises a support consisting of a table 44 rotating about a vertical axis A, generally disk shaped, situated vertically close to the lower wall 37 of the enclosure 34, and comprising two emplacements 45 for powder tanks 27 diametrically opposed to the axis of rotation A of the table and a passageway opening 46 situated at 90° to these two emplacements 45.

Thus, the rotating table 44 makes it possible to make a passageway between the enclosure and the lower compartment 38 when the opening 46 of the table is opposite the opening 36 of the lower wall 37 of the enclosure 34.

Means of vibrating the powder tanks 27 may be placed on the rotating table 44, in the emplacements 45 of the powder tanks 27. These vibration means may consist of one vibrating table 47 for each emplacement 45, making it possible to distribute the powder in the tank 27 placed on this vibrating table 47. These vibrating tables 47 are not necessary for certain types of powder, when the tanks 27 consist of fluidized troughs. They are always used when the tank 27 is a powder carton.

The feeding station 33 also comprises an assembly 48 comprising a plurality of pneumatic powder pumps 49 placed above the rotating table 44, each of the pumps 49 being connected, on the discharge side, to a flexible pipe 17 feeding a gun 10, only the portion thereof close to the assembly 48 being shown, and, on the intake side, to a rigid pipe 50 for sucking the powder from the powder tank 27, this assembly 48 being mounted on a mechanical module 52 which moves it up and down.

The feeding station 33 comprises a powder return pipe 22 originating from a cyclone 3 opening into the powder tank 27 and capable of being raised above the tank 27. This pipe 22 is associated with the previously described assembly 48 in order to be moved by the mechanical module 52 in the same manner as the suction pipes 50.

Furthermore, the assembly 48 may be furnished with powder level detectors, not shown.

In addition, the station 33 comprises means of cleaning the inside of the suction pipes 50 and means of cleaning the outside of the suction pipes 50, all placed in the lower compartment 38 situated beneath the enclosure 34.

The means of cleaning the inside of the suction pipes 50 consist of air blower nozzles 53 around which the rigid pipes 50 are connected in a sealed manner, each of these blower nozzles 53 being placed in vertical alignment with a suction pipe 50, the air jet originating from the nozzles 53 being directed vertically upward and making it possible to clean the inside of a rigid suction pipe 50, and the inside of the pump 49 and the flexible pipe 17 that are connected thereto.

The means of cleaning the outside of the suction pipes consist of air blower nozzles 54 placed around the vertical trajectory of each of the pipes 50, the air jet originating from the nozzles 54 making it possible to clean the outside of the rigid suction pipes 50.

The blower nozzles 54 produce an air jet directed obliquely downward, in the direction of the powder suction pipes when the latter are lowered. These nozzles 54 are attached to a support 55 contained in the compartment 38.

The pipes 50 are blown out by the nozzles 54 when the pipes 50 are lowered and/or raised toward or away from the nozzles 53.

In a manner identical to the suction pipes 50, the nozzles clean the powder return pipe 22.

The feeding station 33 also comprises aspiration and filtration means comprising a fan 56 connected to an upper compartment 57 situated above and behind the enclosure 34.

Each side compartment 42 contains a cylindrically-shaped filtration cartridge 58, whose upper portion 59 forms an opening communicating with the upper compartment 57 and whose bottom 62 is closed. The side wall 63 of each cartridge 58 consists of a filter paper making it possible to separate the powder contained in the aspirated air.

A removable receptacle 64 is present beneath each cartridge 58 to collect the powder that has accumulated on the wall 63 of the cartridge 58 each time the filtration cartridges 58 are unblocked by a short, sharp counter-current injection of a compressed air jet into one cartridge 58, and then into the other.

The aspiration is performed by the fan through the upper compartment 57 then the cartridges 58. Each cartridge 58 is placed in one of the compartments 42 communicating with the enclosure 34 through a top opening 39, and also communicating with the lower compartment 38 through a bottom opening 41, itself communicating with the enclosure 34, through the opening 36 in the lower wall 37 of the enclosure 34.

When the shutters 43 are lowered and close off the bottom openings 41, the aspiration of the enclosure 34 is performed through the top openings 39; when the shutters 43 are raised and close off the top openings 39, the aspiration of the enclosure is performed through the top openings 41, via the lower compartment 38 and the opening 36.

Thus, the aspiration in the enclosure 34 may be performed by the openings 36 or 39.

The station 33 also comprises a command and control device, not shown, making it possible to control the operation of motors, not shown, allowing the movement of the assembly 48, the shutters 43, the rotating table 44, and the aspiration and blowing of the pumps 49 of the assembly, of the nozzles for cleaning the inside 53 and the outside 54 of the suction pipes 50, of the fan and the periodic unblocking of the cartridges 58.

The method of changing color for a powder station 33 according to the invention may be described from an initial position of feeding in a first color represented in FIG. 3, wherein:
the rotating table 44 is in a position in which a first emplacement 45 of the powder tank 27 is situated in vertical alignment with the powder suction pipes 50.
the mechanical module 52 holds the free end of the suction pipes 50 in the powder tank 27 below the powder level. The pneumatic pumps 49 aspirate the powder through the suction pipes 50 and discharge it into the flexible pipes 17 to feed the spray guns 10 in the booth 2.
the top openings 39 in the side wall 40 of the enclosure 34 are open and the bottom openings 41 are closed off, the shutters 43 being in the lowered position; thus the aspiration in the enclosure 34 is performed through the top openings 39.

This first position corresponds to feeding in a first color.

When the change of color is commanded, the station 33 passes through an intermediate position, shown in FIG. 2, wherein:
the table 44 remains in the same position,
the mechanical module 52 raises the assembly 48 so that the free end of the suction pipes 50 is above the wall of the powder tank 27. The pneumatic pumps 49 are stopped,
the top openings 39 of the side wall 40 of the enclosure 34 remain open and the bottom openings 41 are closed off, the shutters 43 being in the lowered position; the aspiration in the enclosure 34 is performed through the top openings 39.

A third cleaning position, shown in FIG. 4, is then reached:
the table 44 rotates 90° in order to bring the opening 46 of the table 44 opposite the assembly 48,
the top openings 39 of the side wall 40 of the enclosure 34 are closed and the bottom openings 41 are open, the shutters 43 being in the raised position; the aspiration in the enclosure 34 is performed through the bottom openings 41 via the lower compartment 38 and the opening 36,
when the table 44 has rotated, the mechanical module 52 lowers the assembly 48 so that the free end of the suction pipes 50 and that of the powder return pipe 22 traverses the opening 46 of the table 44 and the opening 36 of the lower wall 36 of the enclosure 34 and comes into contact with the nozzles 53 for cleaning the inside of the suction pipes 50 situated in the lower compartment 38. The pneumatic pumps 49 may or may not be stopped,
the nozzles 53 for cleaning the inside of the suction pipes 50 and the nozzles 54 for cleaning the outside of these same pipes blow clean the pipes 50 and the powder return pipe 22 that have been in contact with the powder; the inside of the pneumatic pumps 49 and of the flexible pipes 17 for feeding the guns 10, connected to the suction pipes 50, is also cleaned. The powder detached by the nozzles 54 from the outside of the suction pipes 50 or the powder return pipes 22 is moved toward the filtration cartridges 58 by the air aspirated by the fan via the bottom openings 41.

The station 33 then adopts a fourth intermediate position, in which:
the table 44 remains in the same position,
the pneumatic pumps 49, the nozzles 53 for cleaning the inside of the pipes 50, the nozzles 54 for cleaning the outside of the pipes 50 are stopped,
the mechanical module 52 raises the assembly 48 so that the free end of the suction pipes 50 and of the powder return pipe 22 is above the walls of the powder tank 27,
the top openings 39 of the side wall 40 of the enclosure 34 are opened and the bottom openings 41 are closed, the shutters 43 being in the lowered position; thus the aspiration in the enclosure 34 is performed through the top openings 39.

Then the station 33 reaches a fifth position in which:
the table 44 rotates 900 in order to reach a position in which a second emplacement 45 of the powder tank 27, on which a tank 27 is positioned containing a powder of a new color, is situated in vertical alignment with the powder suction pipes 50 and the powder return pipe 22,
when the table 44 has rotated, the mechanical module 52 lowers the assembly 48 in order to bring the free end of the suction pipes 50 and of the powder return pipe 22 in the powder tank 27 below the powder level.

The pneumatic pumps 49 aspirate powder through the suction pipes 50 and discharge it into the flexible pipes 17 to feed the spray guns 10 of the booth 2 with a new color,
the top openings 39 of the side wall 40 of the enclosure 34 are open, and the bottom openings 41 are closed, the shutters 43 being in the lowered position; thus the aspiration in the enclosure 34 is performed through the top openings 39.

In this position, the change of color is effected and the spray guns 10 are fed with the new color.

This operation of the feeding station 33 automates the steps of changing color concerning the station 33. The tank 27 containing the new color may be placed on the rotating table 44 in concurrent operating time before the change of color, causing no delay, then the rest of the operations are automated. This automation limits the time taken to change color to a few minutes.

It is of course possible to provide break times making it possible to complete the operations on the other portions of the installation.

According to the embodiment presented, the changes of color are performed by carrying out all the rotations of the table 44 in the same direction for a first change of color, then all in the opposite direction for the next change.

In another embodiment, not shown, the presence of two openings 46 on the table 44, diametrically opposed and situated at 90° to the emplacements 45, makes it possible to carry out the rotations always in the same direction.

Furthermore, the rotating table 44 makes it possible to carry out changes of powder tank 27 for one and the same color, in order, for example, to replace a powder carton that has been emptied with a full powder carton. Specifically, in this case, the cleaning step is not necessary; it is sufficient to raise the assembly 48, cause the table 44 to pivot to bring the second tank 27 into vertical alignment with the suction pipes 50, then to lower the assembly 48.

According to other embodiments not shown, the rotating table may be replaced by a table that moves in translation and also has several emplacements for powder tanks, and a passageway opening. According to one of these embodiments, two emplacements for powder tanks are situated either side of a passageway opening. Thus the powder tanks and the passageway opening may be brought alternatively by translation of the table to vertical alignment with the suction pipes.

The invention is not limited to the embodiments described; on the contrary, it embraces all the variants thereof. In this way, in particular, the table 44 may comprise a variable number of openings 46, and the emplacements 45 for powder tanks 27 may also be present in variable numbers.

1. A feeding station for an electrostatic powdering installation comprising at least one spray gun, comprising:
an enclosure having an opening toward the outside,
air aspiration and filtration means,
a support on which at least one powder tank is placed,
an assembly comprising at least one pneumatic powder pump placed above the support, the pumps being connected, on one side, to a flexible pipe for feeding a gun, and on another side, to a rigid suction pipe for sucking powder from the powder tank, this assembly being mounted on a mechanical module making it possible to move it vertically, means of cleaning an inside of the suction pipes and means (54) of cleaning the outside of the suction pipe being placed beneath the support in vertical alignment with the suction pipe, the support comprising a movable table comprising at least one emplacement for a powder tank and at least one opening allowing passage of the suction pipe and its vertical positioning by the mechanical module close to the automatic means of cleaning the inside of the suction pipes and of the automatic means (54) of cleaning the outside of the suction pipe, an emplacements or an opening capable of being positioned in vertical alignment with the suction pipes by rotation and/or translation of a table in a substantially horizontal plane, wherein the means of cleaning the inside of the suction pipe and the means of cleaning the outside of the suction pipe are placed in a lower compartment situated beneath the enclosure and communicating with the enclosure through an opening made in its lower wall, this opening being left free by the rotating table, when the opening of the table is in vertical alignment with the suction pipe.

2. The feeding station as claimed in claim 1, wherein the table is mounted to rotate about a substantially vertical axis, positioning of the emplacement or of the opening in vertical alignment with the suction pipe being obtained by rotation of the table about the axis.

3. The feeding station as claimed in claims 1, wherein aspiration in the enclosure is achieved through a side wall of the enclosure or through the opening made in a lower wall of the enclosure, the aspiration through the side wall being able in this case to be stopped.

4. The feeding station as claimed in claim 1, wherein the means of cleaning the inside of the suction pipe comprise air blower nozzles, each of the blower nozzles being placed in vertical alignment with a plurality of said suction pipe and an air jet emanating from the nozzles being directed substantially vertically upward and making it possible to clean the inside of a rigid suction pipe, and the inside of the pump and of the flexible pipe that are connected thereto.

5. The feeding station as claimed in claim 1, wherein the means of cleaning the outside of the suction pipe comprise air blower nozzles placed on at least one vertical support, an air jet emanating from the nozzles making it possible to clean the outside of the rigid suction pipes.

6. The feeding station as claimed in claim 5, wherein the blower nozzles intended to clean the outside of the rigid powder suction pipes produce an air jet directed obliquely downward, in a direction of the powder suction pipes when the latter are positioned vertically close to the means of cleaning the inside and outside of these pipes.

7. The feeding station as claimed in claim 1, wherein the table comprises means of vibrating a powder tank placed on the table, in at least one emplacement of a powder tank.

8. The feeding station as claimed in claim 1, wherein the aspiration means comprise a fan connected to at least one top opening made in the side wall of the enclosure and to at least one bottom opening communicating with the lower compartment, at least one shutter making it possible to close off alternatively the high openings and the bottom openings, the aspiration being performed only through the lower compartment and the bottom openings during the cleaning of the suction pipe.

9. The feeding station as claimed in claim 1, further comprising a powder return pipe originating from a cyclone opening into the powder tank and able to be raised above the tank.

10. The feeding stations as claimed in claim 2, wherein the rotating table comprises at least two emplacements for the powder tank, so that the powder tank can be placed on the table on one emplacement while a first tank is being used.

11. The feeding station as claimed in claim 10, wherein the rotating table comprises two emplacements for the powder tank, diametrically opposed on the rotating table, and an opening situated at 90° from the two emplacements.

12. The feeding station as claimed in claim 1, wherein the filtering means comprise a wall of at least one filtration cartridge traversed by the aspiration air, this wall comprising of a filtering medium preventing powder particles from passing through, a movable receptacle being present beneath each cartridge, allowing the powder which has accumulated on the wall to be collected during a periodic unblocking operation.

13. The feeding station as claimed in claim 1, wherein the assembly comprises a powder return pipe whose end is placed vertically in a similar manner to the suction pipe and which is cleaned by the means of cleaning the inside of the suction pipe and the means of cleaning the outside of the suction pipe.
